(19) United States
(12) Patent Application Publication
(10) Pub. No.: US 2010/0315367 A1
(43) Pub. Date: Dec. 16, 2010

(54) Necktie with Electronic Display

(75) Inventor: Aaron Moy, Eden Prairie, MN (US)

Correspondence Address: Aaron Moy, 18160 Settlers Way, Eden Prarie, MN, 55347, US

(73) Assignee: BOBBLESIGNS.COM LLC, Eden Prairie, MN (US)

(21) Appl. No.: 12/814,450

(22) Filed: Jun. 12, 2010

Related U.S. Application Data
(60) Provisional application No. 61/186,843, filed on Jun. 13, 2009.

(51) Int. Cl. A41D 25/00; G06F 3/041

(52) U.S. Cl. 345/173; 2/144; 345/501

(57) ABSTRACT

Embodiments of the invention generally provide a wearable necktie to which is attached a video display 14. A central processing unit 16 within the device controls the images which are visible on display 14. The user may select digital representations of images, drawings, motion pictures or text and place these digital representations into digital data storage media 24 which is accessible to central processing unit 16. The user may select the order and duration of the images to be shown on display 14, and the image display sequence is executed by 16 during the operation of the invention. Electrical energy is supplied by electrical power source 18. While the device is in operation, the user may wear this device around their neck in a manner customary for the wearing of neckties.

### CROSS-REFERENCE TO RELATED APPLICATIONS

This application claims the benefit of provisional patent application Ser. No. 61,186,843, filed 2009 Jun. 13 by the present inventor.

### FEDERALLY SPONSORED RESEARCH

Not Applicable

### SEQUENCE LISTING OR PROGRAM

Not Applicable

### BACKGROUND

1. Field of Invention

This invention relates generally to a necktie that is combined with an electronic visual display such that the user may convey images, messages or motion pictures to those in the proximity.

2. Prior Art

Quite often attire worn by persons serves as a means of style and personal self expression rather than for providing physical comfort. This assertion is extraordinarily true for the class of clothing accessories commonly known as neckties. Traditionally neckties are admired for their static visual elements, such as the fabric utilized in construction, the breadth of the blade, or the colors and patterns imprinted on the outer surface. While many patents have dealt with the manner in which the knot of a necktie is tied, or a simulation thereof, some inventors have attempted to add personalization or novelty to the necktie. Mirharooni, in U.S. Pat. No. 6,584,618 added a label to neckties where the name of an individual could be signified. Crosier, in U.S. Pat. No. 5,073,987, invented a necktie that holds and displays photographs. Neckties with an appearance related to sports teams were described by Wilsey in U.S. Pat. No. 5,036,550. For the purposes of adding utility Nicolai et al. in U.S. Pat. No. 5,435,011 and Perkins in U.S. Pat. No. 5,881,383 both described adding pockets to a necktie. Shukla and Shukla illustrated the utilization of the necktie as an information source by which messages were printed on the necktie surface (U.S. Pat. No. 5,745,918).

Some electronic elements have been incorporated into neckties previously. Gilson concealed a flashlight inside a necktie (U.S. Pat. No. 5,836,670). Preisler (U.S. Pat. No. 5,927,842) and Hong (U.S. Pat. No. 6,336,730) each added discrete light emitting diodes (LEDs) to the face of neckties such that points of light could flash individually or in an organized pattern. The bowtie of Seider in U.S. Pat. No. 4,283,797 was illuminated by battery powered light bulbs. However, in all of these cases, the basic visual appearance of their devices remained unchanging. At best, for the neckties that employed a series of light emitters, the user could only adjust the frequency, intensity or pattern in which the discrete light emitters were activated.

These previous attempts have suffered from the inability to quickly and easily customize the appearance of the necktie after manufacture. For the necktie that offered a pocket for interchangeable photographs, such changes elicited physical effort from the user which required several seconds at minimum to accomplish. What is needed is a necktie with a striking visual appearance. An appearance that can be varied without burdensome interaction from the user.

Static, passive graphics on neckties could be replaced or enhanced by illuminated electronic displays that are commonplace in myriad products already. Such displays can utilize varied technical approaches, including but not limited to thin film transistor liquid crystals (e.g. U.S. Pat. No. 6,583,777), light emitting diodes (e.g. U.S. Pat. No. 5,184,114) and organic light emitting diodes (e.g. U.S. Pat. No. 7,538,343). To date, no disclosed device has mated electronically addressable image displays with neckties, as does the present invention described henceforth.

### SUMMARY

The present invention is a new device for displaying photographic, video or text images on a wearable apparatus commonly known as a necktie. This device is portable, allowing the user to advertise or otherwise communicate to those around him or her via a portion of the necktie that conveys visual media electronically. The electronic display portion of this device generally consists of an array of picture elements which are individually addressable and changeable such that the pattern of light being emitted by this display is representative of a drawing, photograph, motion picture or conveyance of language. Current implementations of this display technology include backlit liquid crystal displays (LCD), light emitting diodes (LED), organic light emitting diodes (OLED) and electroluminescent (EL) displays, although other display technologies may be employed as part of the present invention.

A central processing unit controls the images which appear on the display. A user may store digital representations of drawings, photographs, motion pictures, text and/or pictographic symbols on media accessible to the processing unit, from which the processing unit will subsequently evoke a variation of colors and intensities of light on the display such that images are externally viewable by spectators. Because the user selects the images that are to be displayed on the device, the invention is readily customizable in expressing or communicating that which the user desires to convey. For example, the user may wish to display digital photographs or videos of select persons, animated characters, company or sports team logos, places, machinery or ideas to be displayed by the device. In an exemplary mode of the present invention, a specific photographic image may be shown indefinitely on the display screen of the device, or a series of images and/or videos may be shown on the display screen of the device, each being visible for a given duration.

### DRAWINGS—FIGURES

FIG. 1 is a front view of the device in operation

FIG. 2 is a backside view of the device

FIG. 3 is a backside view of the device

FIG. 4 is a cross sectional view of the device

FIG. 5 is an exploded view of the device

FIG. 6 is a front view of the enclosure

FIG. 7 is a rear view of the enclosure

FIG. 8 is a front view of an alternative embodiment

FIG. 9 is a front view of an alternative embodiment where the enclosure and display screen are separated

FIG. 10 is a cross section view of an alternative embodiment where the enclosure and display screen are separated

FIG. 11 is a cross section view of an alternative embodiment where the enclosure and display screen are separated

FIG. 12 is a front view of an alternative embodiment with multiple display screens

FIG. 13 is a front view of an alternative embodiment with a display screen that exhibits a tall aspect ratio

### DRAWINGS—REFERENCES NUMERALS

10 Front surface of necktie

10A Left rear panel of necktie

10B Right rear panel of necktie

12 Enclosure

14 Electronic display screen

16 Central processing unit

18 Electrical power source

20 Display control conduit

22 Electrical power conduit

24 Digital media storage

26 Media access conduit

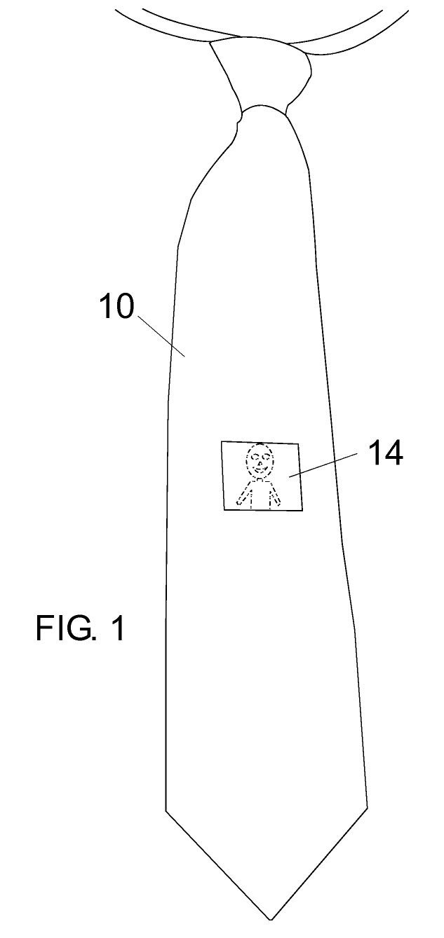

### DETAILED DESCRIPTION—FIGS. 1 THRU 7—PREFERRED EMBODIMENT

FIG. 1 is a view of the assembled device from the front in operation. In this instance, a necktie that has already been knotted in a manner traditionally applied to the wearing of neckties is depicted. The display screen 14 is affixed behind the front necktie surface 10. An area of necktie front surface 10 is cut out to allow display screen 14 to be visible. A phantom image of a human is depicted on 14 to exemplify where an image may be viewed by spectators during device operation. While the display screen 14 could be placed anywhere on the necktie, 14 should generally be viewable between the knotted portion at the top of 10 and the triangular point portion at the bottom of 10.

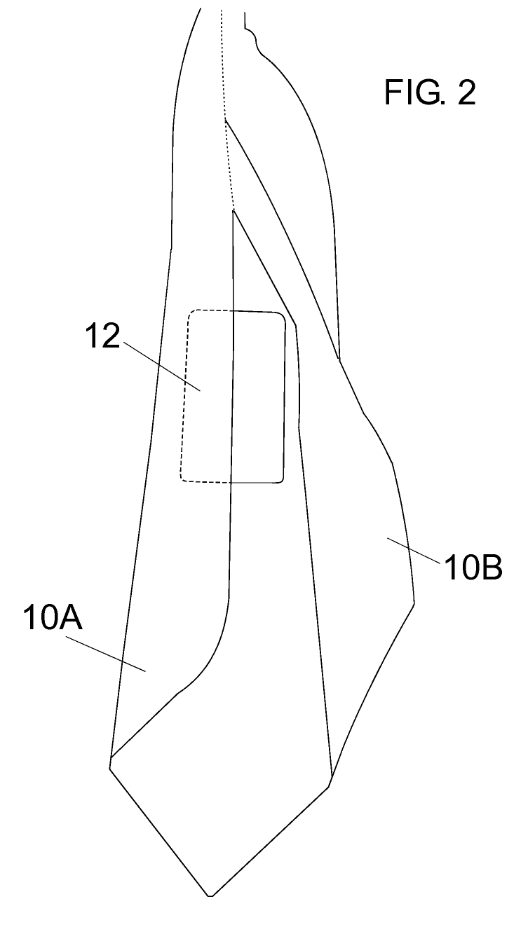

FIG. 2 is a backside view of the device, with right rear panel of necktie 10B being pulled up and away from enclosure 12. Under normal device operation, left rear necktie panel 10A lies within the same plane as right rear necktie panel 10B, concealing enclosure 12. However, either of or both 10A and/or 10B could be pulled away from 12 to permit the user to access control switches, electrical ports or media slots on 12.

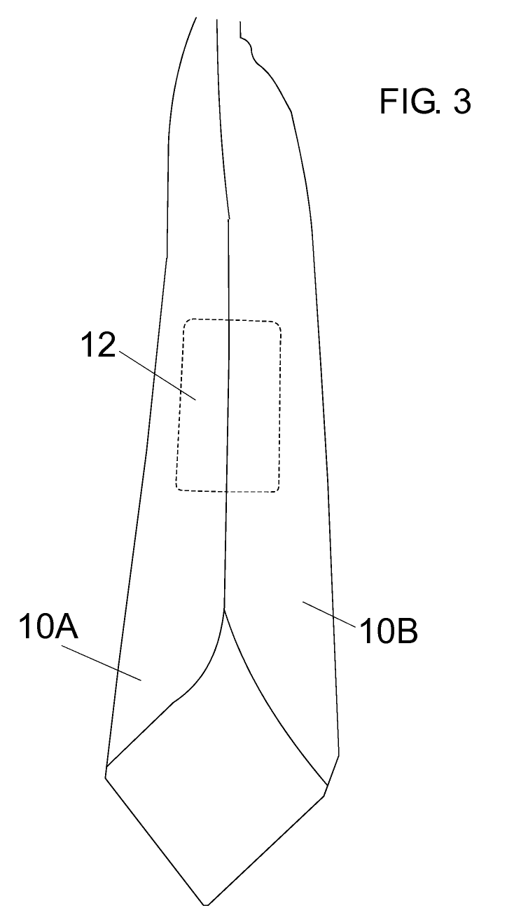

FIG. 3 is a backside view of the device, with right rear necktie panels of 10A and 10B being in a position consistent with the ordinary operation of the device, concealing enclosure 12. The proximate location of 12 as it lays behind 10A and 10B is marked by the dashed lines.

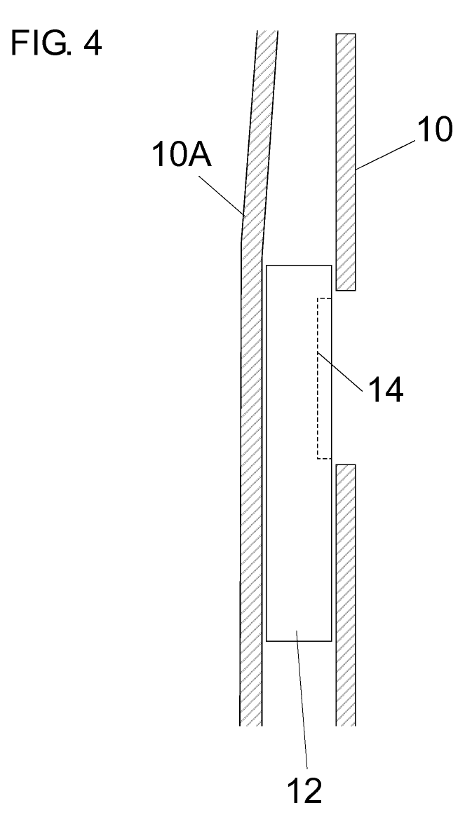

FIG. 4 is a cross sectional view showing how enclosure 12 is situated between left rear necktie panel 10A and front necktie surface 10. An area of 10 is removed to allow light from display screen 14 to be externally viewable.

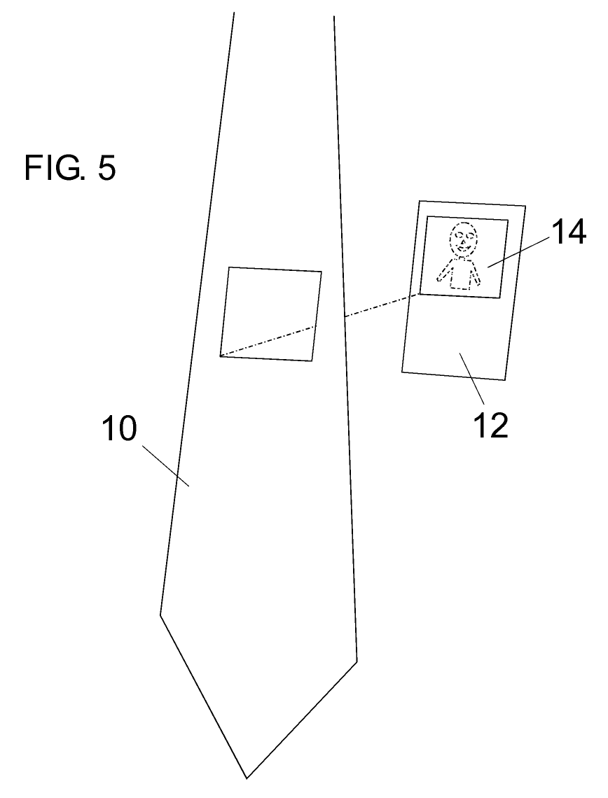

FIG. 5 is an exploded view of the device, where the necktie front surface 10 is situated in front of enclosure 12. A phantom image of a human is depicted on 14 to exemplify where an image may be viewed by spectators during device operation.

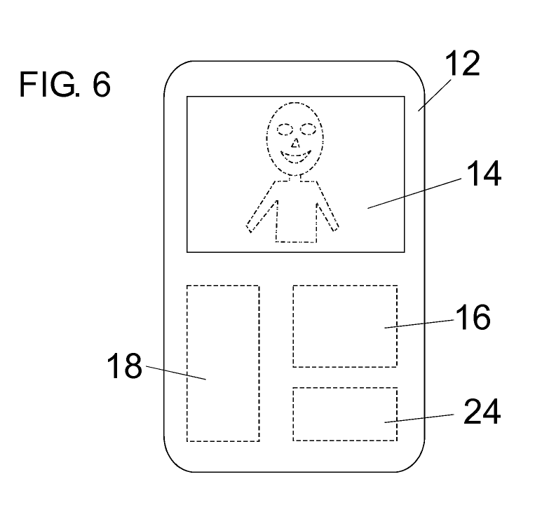

FIG. 6 is a front view of the enclosure 12. Display screen 14 is visible from this view. Central processing unit 16, electrical power source 18 and digital media storage 24 are housed inside 12. Relative locations of 14, 16, 18 and 24 to one another are shown for purposes of visualization only. These relative locations need not be followed in the actual manifestation of the present invention. A phantom image of a human is depicted on 14 to exemplify where an image may be viewed by spectators during device operation.

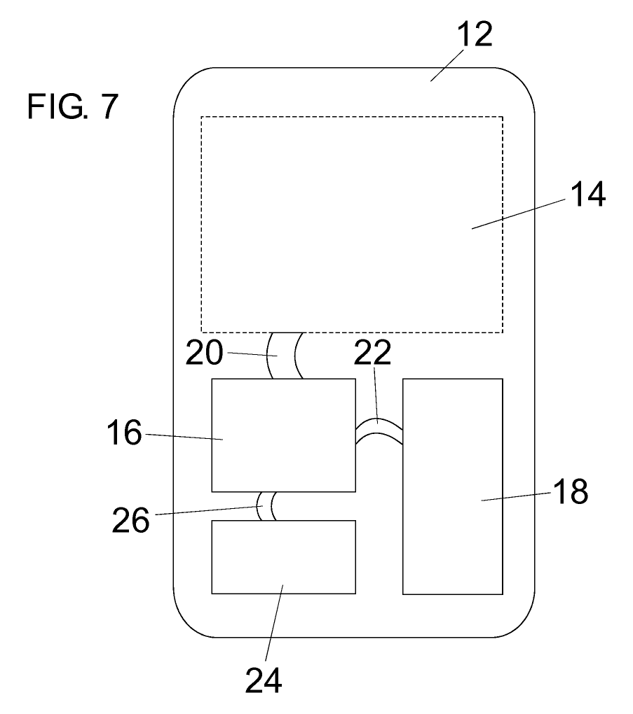

FIG. 7 is a rear exposed view of enclosure 12. Central processing unit 16 connects to display screen 14 through display control conduit 20. Electrical power source 18 connects to 16 through electrical power conduit 22. 16 connects to digital media storage 24 through data transfer conduit 26. Relative locations of 14, 16, 18 and 24 to one another are shown for purposes of visualization only. These relative locations need not be followed in the actual manifestation of the present invention.

### ASSEMBLY AND OPERATION—PREFERRED EMBODIMENT

In the preferred embodiment, a necktie 10 should be previously constructed utilizing materials and techniques previously developed and adopted by makers of apparel. The necktie may be constructed chiefly from any fabric or combination of fabrics such as, but not limited to, silk, cotton or polyester as the fabricator of the present invention deems practicable. The present invention is not limited to a specific size or style of necktie. However in the best mode, said necktie should be elongated in appearance, with one broad end whose lateral breadth dimension tapers from the blade of the tie to a smaller value as the necktie traverses along its longitudinal axis toward the tail of the tie. The necktie should measure of sufficient length to permit said necktie to be worn around the neck of a person and knotted, where the blade and tail of said necktie rest between the chest and waist on the frontal torso of said person.

The most conspicuous portion of the present invention is the electronic display screen 14 (FIG. 1). The function of display screen 14 is to generate patterns and colors of light so as to convey the appearance of images to those viewing the front, emissive surface of 14. For the purposes of discussion in this document, images include, but are not limited to, visual representations of photographs, motion pictures, drawings, charts, text or pictographs. The actual implementation of 14 is a choice left to the discretion of the fabricator. Display screens currently employed in consumer devices rely on technologies such as backlit thin-film transistor liquid crystal displays (LCDs), light emitting diodes (LEDs) and organic light emitting diodes (OLEDs). Any of these aforementioned technologies can be employed as the display screen 14, but other suitable technologies for 14 may also be chosen as well which will continue to be encompassed by the scope of the present invention. In the preferred embodiment, 14 contains an array of individually addressable picture elements (pixels), and each pixel is capable of emitting light with the appearance of a particular, configurable color. In combination, these pixels are capable of generating a pattern of light that is reminiscent of light which reflects off a photograph. 14 may also serve an additional function of sensing when and where the externally viewable portion of display screen 14 is touched, and be able to relay this information to the central processing unit of the present invention. In best mode, the physical size of 14 should be large enough to be viewable by spectators but sufficiently small so as to be contained within 10.

Central processing unit 16 is an electronic component with the primary function of dictating and controlling the images displayed by 14. 16 controls the light intensities and colors emitted by the pixels of 14 in proper combination so as to generate the appearance of a recognized image on 14. 16 also controls the order and duration of when images appear on 14. In the preferred embodiment, 16 accesses electronic data storage 24 via data transfer conduit 26. 24 stores a collection of digital representations of and including, but not limited to, images, text, videos and computer instruction code. Examples of suitable electronic storage include, but are not limited to, flash memory, hard disk drive, solid state disk drive and random access memory.

Central processing unit 16 is able to retrieve the digital image data from said electronic storage 24 and instruct 14 to recreate the image based on this digital data onto the viewable screen 14. 16 conveys control signals to display screen 14 via display control conduit 20. 20 may be a single physical conduit, or may be divided into multiple instances of 20 as the fabricator of this present invention deems practical. 16 may also control the flow of electrical energy to and from electrical power source 18 via electrical power conduit 22.

Electrical power source 18 provides the electrical energy required for operation of the electrical components of the present invention. In the preferred embodiment, 18 may take the form of a rechargeable battery. That is, a battery whose internal chemical potential state may be refreshed by supplying additional external electrical current. Examples of such components are batteries employing lithium-ion, lithium polymer, nickel metal hydride or nickel cadmium electrochemical materials. The fabricator may also select other options for 18, such as, but not limited to, a non-rechargeable battery, a storage capacitor, a fuel cell, a photovoltaic cell or a thermo-electric generator.

In the preferred embodiment, major components of the present invention 14, 16, 18, 20, 22, 24 and 26 may be housed together inside enclosure 12 (FIG. 7). 12 is a shell which can add robustness and aesthetic appeal to the device by protecting and hiding from casual view the internal components. 12 could be made out of a material such as plastic. 12 could also house additional components such as electronic contact switches, external power connectors, external data transfer cable connectors or removable storage media. FIG. 6 illustrates the front side view of 12, where the image emitting surface of 14 is visible. Relative locations of 14, 16, 18 and 24 to one another as they may lay within 12 are shown for purposes of visualization only. These relative locations need not be followed in the actual manifestation of the present invention.

To assemble the device in best mode, enclosure 12 may have been previously constructed with the aforementioned internal components. One or both necktie rear panels 10A and/or 10B may be lifted away from necktie front surface 10 (FIG. 2). Removal or omission of a length of stitching between 10A and 10B may be required to facilitate the lifting of these rear panels. A hole is cut into the front necktie surface of 10 that is approximately the same size and shape as display screen 14. The front surface of enclosure 12 is placed against the backside of necktie front surface 10 such that such that image emitting surface of display screen 14 is visible through the cutout area in 10 (FIGS. 1, 4 and 5). 12 may be attached to 10 using, but not limited to, adhesive or thread, or temporary fasteners such as a magnet, snap, or hook and loop fastener. In best mode, the mechanism utilized to adhere 12 to 10 should not obstruct the image generated by 14, nor should said mechanism produce visible stains, marks or otherwise mar the aesthetic appearance of 10. 10A and 10B are returned to a position flat against the backside of 10 and the backside of 12 (FIG. 3) following the installation 12. In best mode, the enclosure 12 is situated between necktie front surface 10 and both necktie rear surfaces 10A and 10B (FIG. 4).

To operate the device after assembly, the user may verify that the electrical power source 18 has ample stored energy to provide electrical energy to the electronic system components during use of the device. In the preferred embodiment, a source of external electrical current may be temporarily connected by the user to central processing unit 16. 16 may then redirect the electrical current via electrical conduit 22 to 18 if the instance of 18 takes the form of a rechargeable battery. 16 may monitor the voltage level being output by 18 to determine the level of stored energy by 18, and 16 may report this value to the user by conveying a message on display screen 14 via display control conduit 20. Once 18 has been recharged so that 18 possesses an acceptable level of stored energy, said temporary source of external current is disconnected from 16.

The user may then cause to be modified the contents of the digital data storage collection 24 to which 16 has access. In the preferred embodiment, 24 contains an amount of digital storage volume to hold copies of digital data. This storage may take the form of, but is not limited to, flash memory or hard disk drive. The user may temporarily attach one end of a digital data transfer cable to 16, and the other end of said data transfer cable to another external device such as a computer, telephone or camera. The user then chooses the digital files to be transferred from the external device to the storage medium of 24 via central processing unit 16 and data transfer conduit 26, and then the user initiates said transfer. The digital files will contain representations of the images, videos, text, pictographs or sequence of computer instructions. After completion of the digital data transfer, the user will disconnect said external data transfer cable from 16.

The user may then choose the sequence and duration of visibility for the images, video or text stored in 24 to be displayed on display screen 14, as well as possible visual effects to occur during transitions between images. In the preferred embodiment, the settings and sequence for image display are communicated to the user via text and icons that are shown on the image generating surface of 14 when 16 is in a state dedicated to defining the configuration of the device. The user may interact with 16 through electronic switches connected to 16, through a touch sensitive feedback function of display screen 14, or a combination of both. Touch sensitive feedback by 14 may be employed using common technologies such as, but not limited to, capacitive touchscreens or resistive touchscreens. In general, these touchscreens will not only allow the image from the light emitting display array of 14 to be viewed, but also sense when a person or object contacts with moderate force an area of the externally viewable screen of 14. Said touchscreen can sense the approximate location on 14 where physical contact has been made, and relay this location information to 16 in the form of a geometric coordinate or otherwise encoded piece of data. The computer instruction code (firmware) which operates 16 may then couple the feedback from said touchscreen with locations of icons or virtual buttons which are simultaneously displayed on 14 to determine configuration or selections made by the user in defining the state of the device. Additionally, the user may elect to have the display settings determined by an algorithm built into the operating firmware of central processing unit 16.

Once the user completes configuration of the device, the user may initiate 16 to begin executing the display of selected images to be shown on display screen 14. The user may then adorn the necktie on his or her person in a manner customary with the wearing of neckties. Configuration of the device and execution of the image display sequence may also occur while the user is adorning the necktie. The present necktie invention should be situated on the torso of the user in such a manner that the outwardly viewable portion of 14 is visible to those persons or cameras in the frontal proximity of the user. In this best mode, the succession of images displayed on 14 may illicit a sense of awe or amusement to persons within viewing range of the present invention, or said persons may receive a message or intellectual conveyance from the user of the present invention, or a combination thereof. The user may also elect to orient the position of necktie 10 in any other direction relative to the torso, or the user may choose to display the necktie in another manner without physically wearing the necktie on a torso.

At the discretion of the user, the user may choose to initiate a state of the device such that electrical power is removed or diminished from display screen 14. During the lifetime of an instance of the fabricated invention, the user may refresh the energy stored by electrical power supply 18, cause to be modified the contents of the digital data stored in 24, or cause to be modified the sequence or algorithms selected for the display of the digital images by the invention. The user may also choose to cause to be modified the firmware instruction set which operates central processing unit 16 through the exchange of digital data. The user may choose to operate the present invention while a source of external electrical power is physically connected to the device.

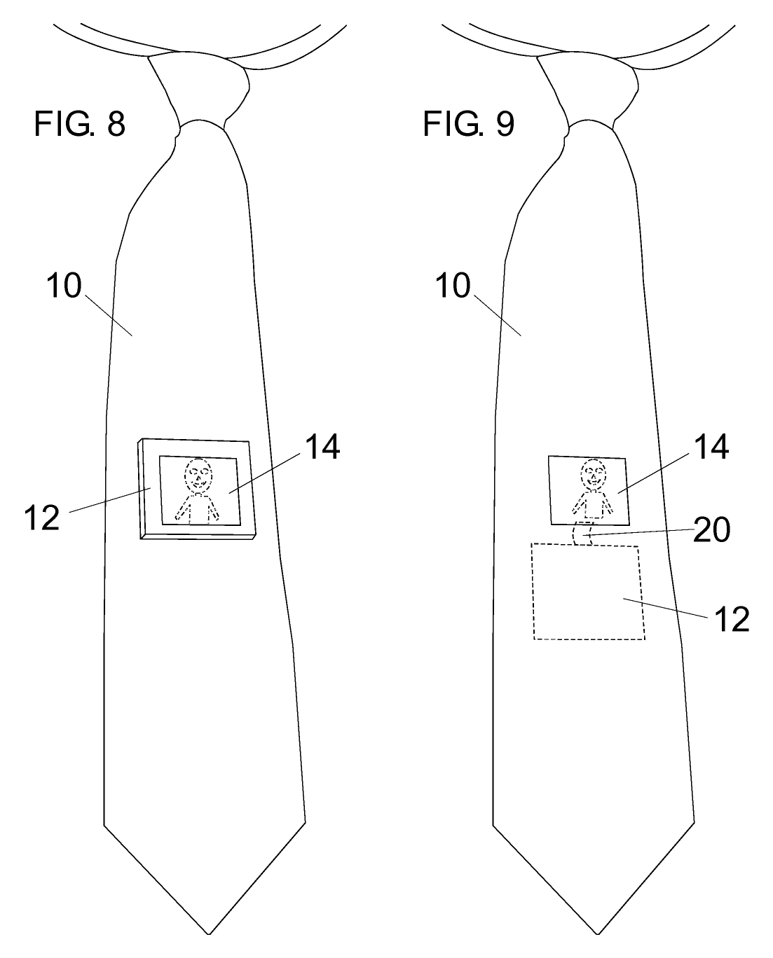

### ADDITIONAL EMBODIMENTS—FIGS. 8 THRU 13

Alternative embodiments exist which provide slight differences in the construction or configuration of present invention, all of which continue to be encompassed by the scope and spirit of the present invention. In the preferred embodiment, central processing unit 16 has access to stored digital data 24. One alternative to internal data storage is removable data storage, such as a removable flash memory card. The user could place digital files directly on a removable flash memory card external to the present invention, and then insert said card into the present invention such that 16 has the ability to retrieve the digital data contents stored on the card. The invention could be constructed to also use a combination of internal digital data storage and removable data storage.

In the preferred embodiment a physical cable was discussed as a means to transfer digital data from external sources to the central processing unit 16. An alternative to said physical connection is a wireless transfer of data. This could be accomplished by adding functionality to 16 such that 16 may receive data via radio frequency communications or modulated light. It may also be possible for 16 to receive digital image, video or message data in real time via wireless communications instead of accessing data kept in digital storage.

In the preferred embodiment the user configured the operation of the present invention through interaction with 16 via electrical switches, touchscreen feedback, or a combination of both. It may also be possible for the user to define the sequence and display of images externally from the device, such as on a computer, and create a digital data file containing these definitions. This digital definition file could then be transferred to, interpreted by and executed by 16.

FIG. 8 is a front view of an alternative embodiment where enclosure 12 is mounted on the front surface of necktie 10. Display screen 14 is viewable and enclosure 12 is not concealed from casual view. 12 attaches to 10 using a bonding method such as, but not limited to, adhesive or thread, or temporary fasteners such as a magnet, snap, or hook and loop fastener. A phantom image of a human is depicted on 14 to exemplify where an image may be viewed by spectators during device operation.

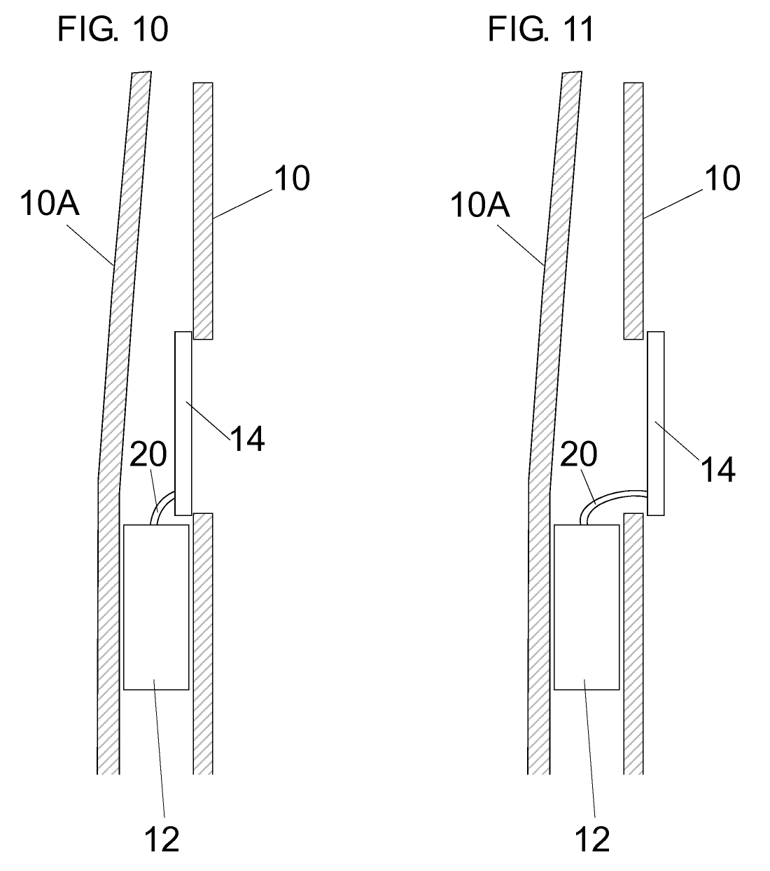

Display screen 14 need not necessarily be contained within enclosure 12. FIG. 9 is a front view of an alternative embodiment where the enclosure 12 is separated from display screen 14. Display control cable 20 connects 12 to 14. 14 is visible to the casual spectator. 14 attaches directly to the rear of tie surface 10 using a bonding method such as, but not limited to, adhesive or thread, or temporary fasteners such as a magnet, snap, or hook and loop fastener. A phantom image of a human is depicted on 14 to exemplify where an image may be viewed by spectators during device operation. FIG. 10 is a cross section view of this embodiment where the 12 is separated from display screen 14. Enclosure 12 remains concealed behind 10, in between 10 and rear panels 10A and 10B (10B not depicted in this cross section). In this embodiment, enclosure 12 may contain instances of previously discussed components central processing unit 16, electrical power source 18, electrical power conduit 22 and data transfer conduit 26.

With display screen 14 separated from enclosure 12, it is also possible to mount 14 to the front side outer surface of necktie surface 10. FIG. 11 is a cross section view of this alternative embodiment. 14 attaches directly to the front of tie surface 10 using a bonding method such as, but not limited to, adhesive or thread, or temporary fasteners such as a magnet, snap, or hook and loop fastener. Display control cable 20 connects 12 to 14. 14 is visible to the casual spectator while 12 remains concealed behind 10. In this embodiment, enclosure 12 may contain previously discussed components central processing unit 16, electrical power source 18, electrical power conduit 22 and data transfer conduit 26.

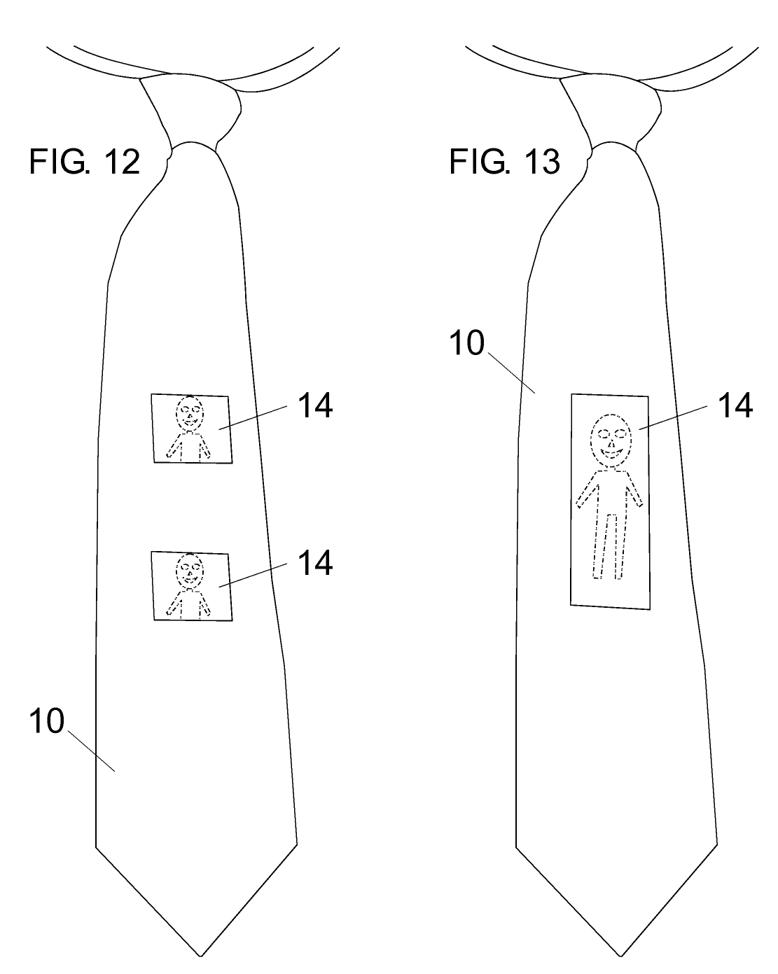

The present invention need not be limited to a single instance of display screen 14. FIG. 12 is a front view of an alternative embodiment where the multiple instances of display screen 14 are attached to necktie surface 10. 14 is attached to 10 in any manner as has been previously discussed in this document. The multiple instances of 14 may all be controlled by a single instance of central processing unit 16. The multiple instances of 14 may be controlled by a multiple instances of central processing unit 16. A phantom image of a human is depicted on 14 to exemplify where an image may be viewed by spectators during device operation. The images displayed by the instances of 14 may be identical to, coordinated with, or independent from one another, based on the discretion of the user. In this embodiment, enclosure 12 (concealed from casual view) may contain previously discussed components central processing unit 16, electrical power source 18, electrical power conduit 22, data storage 24 and data transfer conduit 26.

Although the previous embodiments depicted a display screen 14 as having a rectangular aspect ratio in which 14 appears wider than it does tall, any of the embodiments of the present invention may have an instance of 14 of any practicable shape. FIG. 13 is a front view of an alternative embodiment where 14 exhibits a tall aspect ratio in which its height appears to be larger than its width. A phantom image of a human is depicted on 14 to exemplify where an image may be viewed by spectators during device operation. 14 is attached to necktie surface 10 in any manner as was previously discussed in this document. 14 is visible to the casual spectator while 12 remains concealed behind 10. In this embodiment, enclosure 12 may contain previously discussed components central processing unit 16, electrical power source 18, electrical power conduit 22, data storage 24 and data transfer conduit 26.

It may also be possible to construct the present invention without utilizing an enclosure 12. The major components display screen 14, central processing unit 16, electrical power source 18, electrical power conduit 22, data storage 24 and data transfer conduit 26 may be attached to necktie 10 at any location using any means of adhesion the fabricator deems practicable. The fabricator may also choose to use multiple instances of enclosures 12, and distribute said major components among the instances of 12 in any manner or combination the fabricator deems practicable.

Approaches presented above in the preferred and alternative embodiments of the present invention may be selectively combined in any combination as the fabricator deems practicable in creating a manifestation of the present invention. Relative sizes and relative locations of major components 14, 16, 18, 20, 22, 24 and 26 to one another have been depicted as an aid to visualization and understanding only. These relative sizes and relative locations need not be followed in the actual manifestation of the present invention. The fabricator may also construct the device in a manner in which any or all of the major components are not concealed from casual view, while still falling within the purview of the present invention.

Regardless of the choice of physical construction, the operation of the devices with alternative embodiments remains similar to that of the preferred embodiment. Refreshing of the electrical power source, modification of the stored digital data, and selection and execution of the image display sequence are performed in a manner similar to that previously described for the preferred embodiment.

### CONCLUSION, RAMIFICATIONS, AND SCOPE

Accordingly, the reader will understand that the necktie with electronic display provides a means for the user to easily customize their neckwear and convey an opinion in a novel and dazzling manner. The present invention adds flair to neckties since the electronic screen will display images with vibrancy. Additionally, the displayed images could be motion pictures which will capture the attention of onlookers far more than an unchanging image. The use of digital media among consumers is widespread, ensuring that there is both a market for and a capability of users to transfer images, photos and motion pictures to the present invention in order to create a tailored, expressive piece of wardrobe. Examples of this market include customized digital wallpapers available on cellular telephones and digital photo frames. Modern professional sports venues have installed complex video display walls to entertain fans with photos, animations, videos and information. The present invention captures this spirit by providing users with a personal video display that is incorporated into a wearable necktie

The electronic displays utilized in the manifestations of the present invention need not be limited to any particular technological approach. Although the drawings presented depict image display screens with a flat, rectangular shape, the employment of screens with other shapes, or screens with curved surfaces, is also conceivable in the fabrication of the present invention. If technologically feasible, the display screen of the present invention could encompass a significant length of the visible necktie. The neckwear also need not be constructed from a flexible material. The present invention is equally as applicable to neckties constructed to be rigid or semi-rigid.

It is not necessary that the contents of the digital storage media of the present invention, or the image display sequence definition, be modifiable by the end user. It is possible for the necktie with electronic display to be preloaded with digital content by the distributor or agents thereof. A manufacturer could choose to sell a manifestation of this invention in unassembled form, allowing the end user to complete construction. It is conceivable that an audio speaker could be added to the present invention so that the device provides aural as well as visual stimuli.

Although the description above has presented some specificities about shape, style and choice of materials, these should only be considered aids to visualization of the construction and operation of the device. By no means should said specificities be interpreted as limitations of any embodiment. Accordingly, the scope of the invention should be judged by the claims of this patent and their legal equivalents.

I claim:

1. A necktie capable of displaying electronically generated images comprising: a necktie body featuring an elongated shape, an electronic screen display upon which representations of digital images may be visible, an electronic central processing unit which dictates the images visible on said electronic screen, an information storage medium which said electronic central processing unit may place into or retrieve from a collection of data, and an electrical power source which provides electrical energy to said electronic central processing unit.

2. The neckwear of claim 1, wherein said information storage medium is removable.

3. The neckwear of claim 1, wherein said electrical power source comprises an electrochemical material.

4. The neckwear of claim 1, wherein said electrical power source comprises an electrochemical material, and the potential energy of said electrochemical material may be increased through the application of an electrical current through said electrochemical material.

5. The neckwear of claim 1, wherein said electrical power source comprises a photovoltaic device capable of transforming energy derived from the reception of photons into energy in the form of electric current.

6. The neckwear of claim 1, wherein said electronic central processing unit includes a wireless communications medium that enables said electronic central processing unit to receive data from external devices.

7. The neckwear of claim 1, wherein said electronic screen display senses tactile contact upon the outwardly visible surface of said electronic screen display, and said electronic screen display communicates the location of said tactile contact to said central processing unit.

8. A necktie capable of displaying electronically generated images comprising: a necktie body featuring an elongated shape, multiple instances of electronic screen displays upon which representations of digital images may be visible, an electronic central processing unit which dictates the images visible on said electronic screens, an information storage medium which said electronic central processing unit may place into or retrieve from a collection of data, and an electrical power source which provides electrical energy to said electronic central processing unit.

9. The neckwear of claim 8, wherein said information storage medium is removable.

10. The neckwear of claim 8, wherein said electrical power source comprises an electrochemical material.

11. The neckwear of claim 8, wherein said electrical power source comprises an electrochemical material, and the potential energy of said electrochemical material may be increased through the application of an electrical current through said electrochemical material.

12. The neckwear of claim 8, wherein said electrical power source comprises a photovoltaic device capable of transforming energy derived from the reception of photons into energy in the form of electric current.

13. The neckwear of claim 8, wherein said electronic central processing unit includes a wireless communications medium that enables said electronic central processing unit to receive data from external devices.

14. The neckwear of claim 8, wherein at least once instance of said electronic screen display senses tactile contact upon the outwardly visible surface of said electronic screen display, and said instance of electronic screen display communicates the location of said tactile contact to said central processing unit.
